(19) United States
(12) Patent Application Publication
(10) Pub. No.: US 2018/0226754 A1
(43) Pub. Date: Aug. 9, 2018

(54) ELECTRICAL ASSEMBLY HAVING AN ELECTROMAGNETIC SHIELD FORMED BY AN ADDITIVE MANUFACTURING PROCESS AND METHOD OF MANUFACTURING SAME

(71) Applicant: Delphi Technologies, Inc., Troy, MI (US)

(72) Inventors: Gerald A. Rhinehart,, JR., Lordstown, OH (US); William C. Ketterer, Girard, OH (US)

(21) Appl. No.: 15/428,261

(22) Filed: Feb. 9, 2017

(51) Int. Cl. H01R 13/6581; H01R 43/18

(52) U.S. Cl. CPC H01R 13/6581; H01R 43/18

(57) ABSTRACT

An electrical assembly, such as an electrical connector, is presented. The assembly includes a housing formed of a dielectric material using an additive manufacturing process such as stereolithography, digital light processing, fused deposition modeling, fused filament fabrication, selective laser sintering, selecting heat sintering, multi-jet modeling, multi-jet fusion, or 3D printing. The assembly further includes an electromagnetic shield integrally formed on a surface of the housing by a layer of conductive material deposited on the dielectric material by the additive manufacturing process. A method of manufacturing a housing configured to contain an electrical assembly is also presented. The method includes the steps of forming the housing from a dielectric material using an additive manufacturing process and integrally forming an electromagnetic shield on an external surface of the housing by depositing a layer of conductive material on the dielectric material during the additive manufacturing process.

### TECHNICAL FIELD OF THE INVENTION

The invention generally relates to electrical assemblies, and more particularly relates to an electrical assembly that includes an electromagnetic shield integrally formed by an additive manufacturing process.

### BACKGROUND OF THE INVENTION

It is necessary to provide electromagnetic shielding for certain assemblies to either prevent radio frequency interference (RFI) from radiating from the electrical components within the assembly or electromagnetic interference from being undesirably coupled to electronic components within the assembly. This shielding can be provided by a cast metal housing or cover surrounding the connection system or by incorporating stamped metal parts (shield cans) into the connection systems.

A cast metal housing requires a significant investment in tooling needed to form the housing and this tooling typically lacks flexibility for making design changes to the housing without irreversibly modifying or replacing the tooling. Post process machining of surfaces on the housing is also often required to meet required manufacturing tolerances. The stamped metal shield cans also require a significant investment in tooling and require additional parts and labor to assemble the shield cans into the connector system.

FIG. 1 illustrates an example of an electrical assembly according to the prior art, in this example a shielded electrical connection system 1. The connection system 1 includes electromagnetic shielding in the form of sheet metal shields 2 or “shield cans” incorporated into both a male connector housing 3 which contains male electrical terminals 4 and a female connector housing 5 which contains female electrical terminals 6.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

According to an embodiment, an electrical assembly is provided. The electrical assembly includes a housing formed of a dielectric material using an additive manufacturing process and an electromagnetic shield integrally formed on a surface of the housing by a layer of conductive material deposited on the dielectric material by the additive manufacturing process. The additive manufacturing process may be stereolithography (SLA), digital light processing (DLP), fused deposition modeling (FDM), fused filament fabrication (FFF), selective laser sintering (SLS), selecting heat sintering (SHS), multi-jet modeling (MJM), multi-jet fusion (MJF), or 3D printing (3DP). The surface may be an external surface or an internal surface. The electrical assembly may an electrical connector that further includes an electrical terminal disposed within the housing that is configured to be connected to an electrical conductor, such as a wire.

According to another embodiment, a method of manufacturing a housing configured to contain an electrical assembly is provided. The method includes the steps of forming the housing from a dielectric material using an additive manufacturing process and integrally forming an electromagnetic shield on an external surface of the housing by depositing a layer of conductive material on the dielectric material during the additive manufacturing process. The additive manufacturing process may be stereolithography (SLA), digital light processing (DLP), fused deposition modeling (FDM), fused filament fabrication (FFF), selective laser sintering (SLS), selecting heat sintering (SHS), multi-jet modeling (MJM), multi-jet fusion (MJF), and 3D printing (3DP). The surface may be an external surface or an internal surface. The steps of the method are preferably performed in the order listed above. The electrical assembly may be an electrical connector and the method may further include the step of disposing an electrical terminal be connected to an electrical conductor within the housing.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1 is an exploded perspective view of an electrical connector system in accordance with the prior art; and

FIG. 2 is an exploded perspective view of an electrical connector system in accordance with one embodiment.

### DETAILED DESCRIPTION OF THE INVENTION

An electrical assembly described herein includes a housing that is formed using a multi-material additive manufacturing process, such as stereolithography (SLA), digital light processing (DLP), fused deposition modeling (FDM), fused filament fabrication (FFF), selective laser sintering (SLS), selecting heat sintering (SHS), multi-jet modeling (MJM), multi-jet fusion (MJF), and 3D printing (3DP). The housing further includes an electromagnetic shield that is integrally formed of a conductive material on an external and/or an internal surface of the housing using the same additive manufacturing process A method of forming

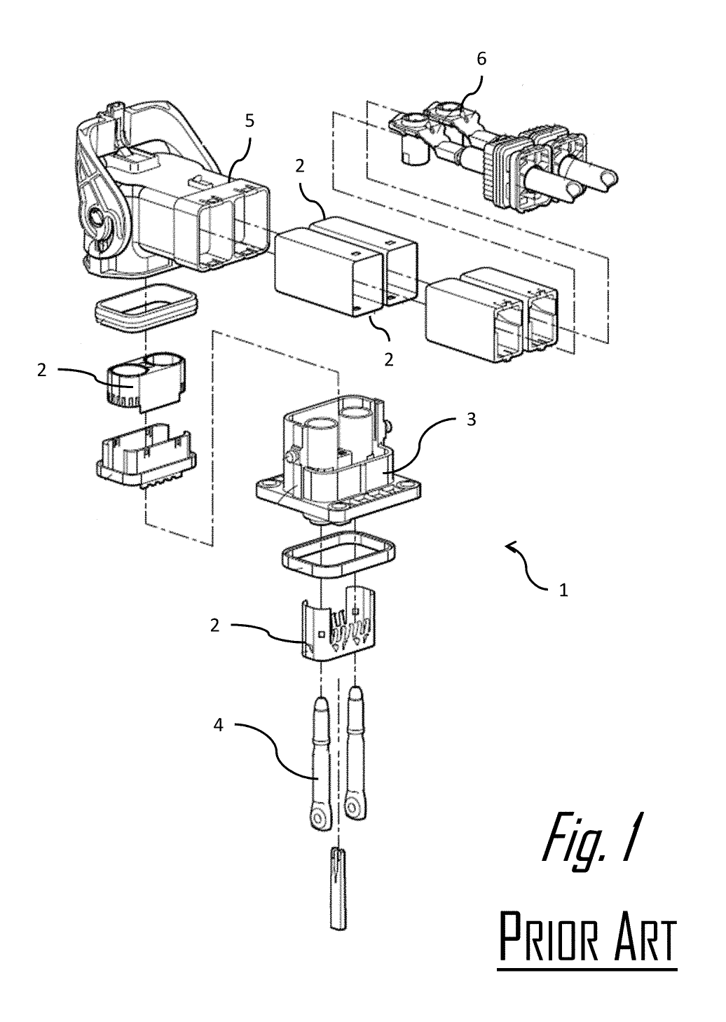

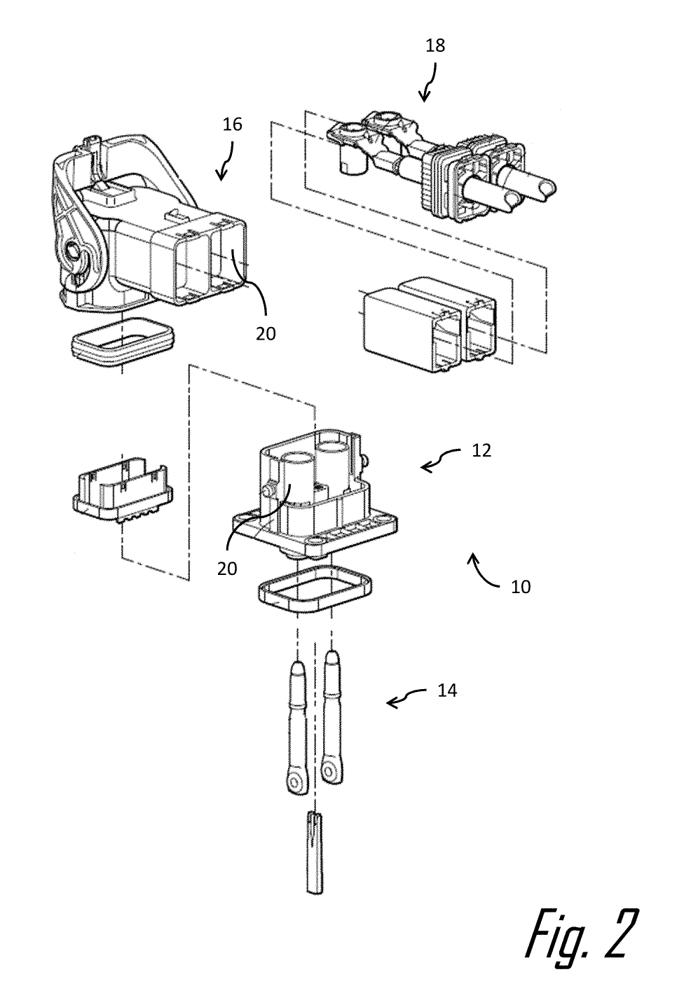

FIG. 2 illustrates a non-limiting example of an electrical assembly, in this particular example a shielded electrical connector system 10. The connector system 10 includes a male connector housing 12 that contains a pair of male terminals 14 and a female connector housing 16 that contains a pair of female terminals 18 configured to receive the male terminals 14. The connector system 10 of FIG. 2 is similar in design to the prior art connector system 1 shown in FIG. 1.

Both the male and female connector housings 12, 16 have a base that is formed of a first material that is dielectric polymer, such as polyamide (PA, NYLON) or acrylonitrile butadiene styrene (ABS) using an additive manufacturing process such as one of the processes listed above. As each connector housing is formed, a layer 20 of a second material that is electrically conductive, such as copper, aluminum, or carbon is deposited on the outer surface of connector housing during the additive manufacturing process. This layer 20 of conductive material has sufficient conductivity to form an integral electromagnetic shield on the connector housing. As used herein, aluminum refers to elemental aluminum as well as aluminum alloys wherein aluminum is the primary constituent. Also as used herein, copper refers to elemental copper as well as copper alloys wherein copper is the primary constituent. Further as used herein, carbon refers to one or more of the electrically conductive carbon allotropes such as graphite, graphene, buckminsterfullerene, and carbon nanotubes.

The male connector housing 12 has the conductive layer 20 on the outer surface of the housing while the female connector housing 16 has the conductive layer 20 on inner surfaces of cavities within the female connector housing 16. When the male connector housing 12 is inserted within the female connector housing 16, the outer surface of the male connector housing contacts the inner surface of the female connector housing, thereby establishing electrical continuity between the layers 20 of the electromagnetic shields of the male and female connector housings 12, 16. As can be seen by comparing FIG. 1 and FIG. 2, this simplifies the connection system design by eliminating sheet metal shield cans from the connector system of FIG. 2.

While the illustrated example of the electrical assembly 10 presented herein is an electrical connection system, other embodiments may be envisioned in which the housing contains electronic components and circuits that are electromagnetically shielded by the conductive layer on the surface of the housing. Yet other embodiments may be envisioned wherein the conductive layer is formed by the additive manufacturing process such that it is embedded within the housing.

Accordingly an electrical assembly 10 having a housing 12, 16 with an integral electromagnetic shield 20 that is formed using a multi-material additive manufacturing process is provided. This electrical assembly 10 provides the benefits of eliminating tooling costs for molds or stampings as well as eliminating separate shields and the labor required to install them into the electrical assembly 10. This further provides design flexibility because the only costs required to make design changes will be due to changes in the computer aided design (CAD) models for the electrical assembly 10.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

1. (canceled)

2. An electrical assembly, comprising:
a housing formed of a dielectric material by an additive manufacturing process selected from a list consisting of stereolithography (SLA), digital light processing (DLP), fused deposition modeling (FDM), fused filament fabrication (FFF), selective laser sintering (SLS), selecting heat sintering (SHS), multi-jet modeling (MJM), multi-jet fusion (MJF), and 3D printing (3DP); and
an electromagnetic shield integrally formed on a surface of the housing by a layer of conductive material deposited on the dielectric material by the additive manufacturing process.

3. The electrical assembly according to claim 2, wherein the surface is an external surface.

4. The electrical assembly according to claim 2, wherein the surface is an internal surface.

5. The electrical assembly according to claim 2, wherein the electrical assembly is an electrical connector and wherein the electrical assembly further comprises an electrical terminal configured to be connected to an electrical conductor, said electrical terminal disposed within the housing.

6. (canceled)

7. A method of manufacturing a housing configured to contain an electrical assembly, said method comprising the steps of:
forming the housing from a dielectric material by an additive manufacturing process selected from a list consisting of stereolithography (SLA), digital light processing (DLP), fused deposition modeling (FDM), fused filament fabrication (FFF), selective laser sintering (SLS), selecting heat sintering (SHS), multi-jet modeling (MJM), multi-jet fusion (MJF), and 3D printing (3DP); and
integrally forming an electromagnetic shield on an external surface of the housing by depositing a layer of conductive material on the dielectric material during the additive manufacturing process.

8. The method according to claim 7, wherein the surface is an external surface.

9. The method according to claim 7, wherein the surface is an internal surface.

10. The method according to claim 7, wherein the steps of the method are performed in the order listed.

11. The method according to claim 7, wherein the electrical assembly is an electrical connector and wherein the method further comprises the step of disposing an electrical terminal connected to an electrical conductor within the housing.
